(19) United States
(12) Patent Application Publication
(10) Pub. No.: US 2004/0251450 A1
(43) Pub. Date: Dec. 16, 2004

(54) Proton-conducting ceramic/polymer composite membrane for the temperature range up to 300 degree C

(76) Inventors: Jochen Kerres, Ostfildern (DE); Norbert Nicoloso, Maburg (DE); Gunther Schafer, Westhofen (DE)

Correspondence Address: MORGAN LEWIS & BOCKIUS LLP, 1111 PENNSYLVANIA AVENUE NW, WASHINGTON, DC, 20004, US

(21) Appl. No.: 10/870,156

(22) Filed: Jun. 18, 2004

Related U.S. Application Data
(63) Continuation of application No. 09/984,531, filed on Oct. 30, 2001, now abandoned.
Application No. 09/984,531 is a continuation of application No. PCT/EP00/03911, filed on May 2, 2000.

(30) Foreign Application Priority Data
Apr. 30, 1999 (DE) 199 19 988.4

(51) Int. Cl. H01B 1/00

(52) U.S. Cl. 252/500

(57) ABSTRACT

A composite membrane comprising organic functional polymers and ceramic nanoparticles (1-100 nm), with the exception of sheet silicates and three-dimensional silicates, with intercalated water and/or a high surface concentration of acidic/basic groups (e.g. hydroxyl) and water. The use of such particles makes possible not only a satisfactorily high mechanical stability of the composite material but also stabilization of the proton concentration necessary for the conductivity in the membrane up to operating temperatures of 300° C. Important factors are the interfaces between polymer and ceramic powder which are formed in the microheterogeneous mixture and allow, if they are present in sufficient number (high proportion of the phase made up of nanosize particles), proton transport at low pressure and temperatures above 100° C. Modification of the polymer/ceramic particle boundary layer by means of different polar boundary groups, preferably on the polymer skeleton, influences the local equilibrium and thus the binding strength of the protic charge carriers. This makes it possible, for example in the case of alcohol/water mixtures as fuel, to reduce the passage of MeOH (where Me is CH₃, C₂H₅, C₃H₇) through the membrane, which is of particular importance for the development of efficient direct methanol fuel cells. Apart from fuel cells, other possible applications are the areas in energy and process technology where steam as well as electric power is produced or required or where (electro) chemically catalyzed reactions are carried out at elevated temperatures at from atmospheric pressure to superatmospheric pressures and/or under an atmosphere of water vapor. The invention further relates to a process for producing and processing such a composite membrane.

This application is a continuation of the national stage entry of PCT/EP00/03911, filed May 2, 2000, the disclosure of which is incorporated by reference.

### FIELD OF THE INVENTION

A composite membrane comprising organic functional polymers and ceramic nanoparticles (1-100 nm), with the exception of sheet silicates and three-dimensional silicates, with intercalated water and/or a high surface concentration of acidic/basic groups (e.g. hydroxyl) and water. The use of such particles makes possible not only a satisfactorily high mechanical stability of the composite material but also stabilization of the proton concentration necessary for the conductivity in the membrane up to operating temperatures of 300° C. The invention further relates to a process for producing and processing such a composite membrane.

### BACKGROUND OF THE INVENTION

Known proton-conducting membranes (e.g. Nafion™), which have been developed specifically for fuel cell applications, are generally fluorinated hydrocarbon-based membranes which have a very high water content of up to 20% in their membrane skeleton. The conduction of the protons is based on the Grotthus mechanism, according to which protons in acid media and hydroxyl ions in alkaline solutions act as charge carriers. There is a long-range structure which is crosslinked via hydrogen bonds and makes the actual charge transport possible. This means that the water present in the membrane plays a vital role in charge transport: without this additional water, no appreciable charge transport through these commercially available membranes takes place; they lose their function.

Other, more recent developments which employ phosphate skeletons in place of the fluorinated hydrocarbon skeleton likewise require water as additional network former (Alberti et al., SSPC9, Bled., Slovenia, Aug. 17-21, 1998, Extended Abstracts, p. 235). The addition of very small SiO₂ particles to the abovementioned membranes (Antonucci et. al., SSPC9, Bled, Slovenia, Aug. 17-21, 1998, Extended Abstracts, p. 187) does lead to stabilization of the proton conduction up to 140° C., but only under operating pressures of 4.5 bar. Without an elevated working pressure, these (and similar) composite membranes also lose their water network above 100° C. and dry out.

A substantial disadvantage of all the abovementioned types of membrane is therefore that they are suitable for use temperatures up to not more than 100° C. even under optimum operating conditions.

### SUMMARY OF THE INVENTION

In one embodiment the invention is a proton-conducting polymer/ceramic particle composite or polymer/ceramic particle composite membrane, characterized in that it comprises a heat-resistant polymer and nanosize oxide containing intercalated water and at the same time having a high concentration of acidic/basic surface OH, wherein the nanosize particles have surface areas of >>20 m²/g, and a mean diameter of <<100 nm. The proton conductor beneficially has a ratio of polymer:oxide of from 99:1 to 70:30 in % by volume.

The proton conductor beneficailly has a percolating ceramic particle network such that in terms of a simple percolation model has a mixing ratio of polymer:oxide of >30% by volume. In one embodiment proton conduction is exclusively via the percolating ceramic particles and their boundary layer to the polymer. Beneficially the polymer component is one or more thermally stable polymer components, i.e., stable above 100° C. In one embodiment the proton conductor has a proton conductivity of >>10⁻ S/cm at T>100° C. and an electrical conductivity a comparable magnitude or less. Preferably, the proton conductor has an electrical conductivity of at least an order of magnitude lower than the proton conductivity.

The proton conductor may be shaped in the form of a flat article, a film, a membrane, or an (electro)catalytic electrode. The proton conductor may be shaped in the form of tubes or crucibles, for example by an extrusion or pressing process. The proton conductor advantageously is characterized in that the composite is stable at a temperature of 250° C. The polymer advantageously has an aryl or hetaryl main chain. The main chain polymer advantageously includes the following building blocks:

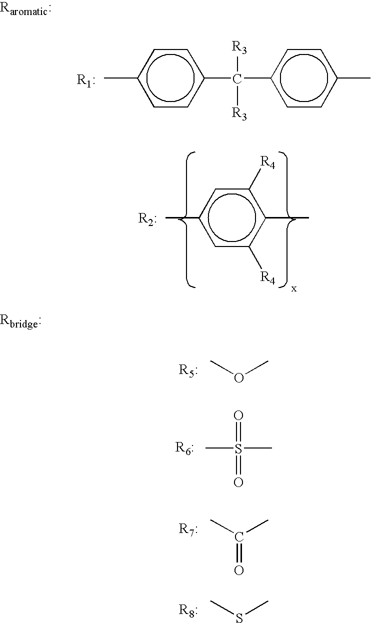

Preferably, the main chain polymer is selected from the group consisting of Poly(ether ether ketone), available as PEEK Victrex®, of formula [R₅—R₂—R₅—R₂—R₇]ₙ, where n is an integer, x=1, and R₄═H; Poly(ether sulfone), available as PSU Udel®, of formula [R₁—R₅—R₂—R₆—R₂]₈, R₂, where n is an integer, x=1, and R₄=H; Poly(ether sulfone), available as PES VICTREX®, of formula [R₂—R₆—R₂—R₅]ₙ, R₂, where n is an integer, x=1, and R₄═H; Poly(phenyl sulfone), available as RADEL R®, of formula [(R₂)₂—R₅—R₂—R₆—R₂]ₙ, R₂, where n is an integer, x=2, R₄=H; Polyether ether sulfone, available as RADEL A®, of formula ([R₅—R₂—R₅—R₂R₂]ₙ—[R₅—R₂—R₆—R₂]ₘ, R₂, where x=1, R₄═H, n and m are integers such that n/m=0.18; Poly(phenylene sulfide) of formula [R₂—R₈]ₙ, R₂, where n is an integer, x=1, R₄=H; or Poly(phenylene oxide) of formula ([R₂—R₅]ₙR₂, where n is an integer, R₄=CH₃,

In one embodiment the hetaryl main chain polymer comprises at least one of the following building blocks:

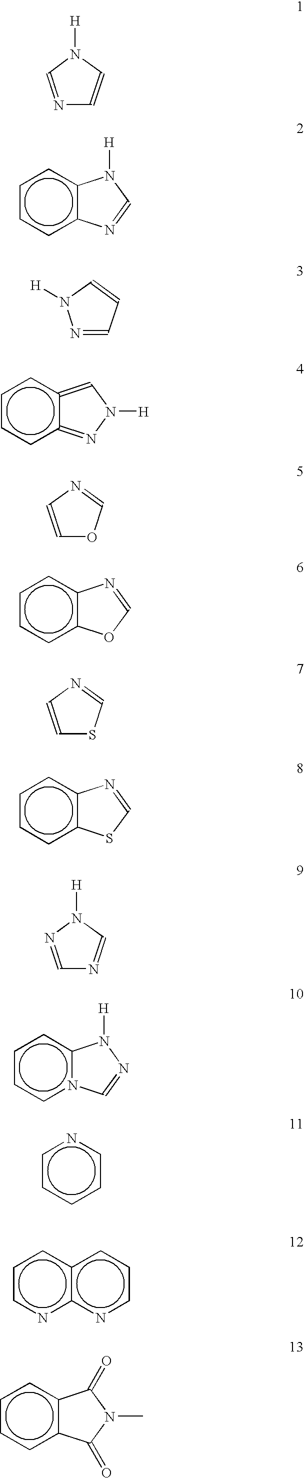

These building blocks of hetaryl polymers are (1) imidazole, (2) benzimidazole, (3) pyrazole, (4) benzopyrazole, (5) oxazole, (6) benzoxazole, (7) thiazole, (8) benzothiazole, (9) triazole, (10) benzotriazole, (11) pyridine, (12) dipyridine, and (13) phthalimide. In one embodiment the hetaryl polymers comprise polyimidazoles, polybenzimidazoles, polypyrazoles, polybenzopyrazoles, polyoxazoles, or polybenzoxazoles.

Advantageously the polymer comprises cation-exchange groups —SO₃M, —PO₃M₂,—COOM, or —B(OM)₂, where M is H, a monovalent metal cation, ammonium, or NR₄ where R is independently H, alkyl, or aryl; or precursors: SO₂X, COX, or PO₃X₂, where X═F, Cl, Br, I, or OR, where R is an alkyl or aryl.

In another embodiment, the polymer comprises the anion-exchange groups NR₄, where R is independently H, alkyl, aryl, pyridinium, imidazolium, pyrazolium, or sulfonium.

The ceramic component is advantageously selected from among:

water-containing and nanosize particles which have OH groups on their surface;

protonated, ion-exchanged mixed oxides which in their original parent compositions form the B-aluminate structure selected from the group consisting of

| | | |
|---|---|---|
| zMe₂O-xMgO-yAl₂O₃ | zMe₂O-xZnO-yAl₂O₃ | zMe₂O-xCoO-yAl₂O₃ |
| zMe₂O-xMnO--yAl₂O₃ | zMe₂O-xNiO-yAl₂O₃ | zMe₂O-xCrO-yAl₂O₃ |
| zMe₂O-XEuO-yAl₂O₃ | zMe₂O-xFeO-yAl₂O₃ | zMe₂O-XSmO-yAl₂O₃ |

or mixed forms of these oxides, where the empirical formulae describe the ranges in which the parent compounds, Me is Na or K, and where the compounds containing alkali metals have been subjected, before they can be used for the membrane, to an ion-exchange process in which the alkali metal ion is removed and the protonated form of the B-aluminate compound is produced, wherein, z=0.7-1.2, x=0.1-10, y=0.1-10, and wherein the proton conductor stable to about 300° C.;

compositions comprising the components MgO, ZnO, CoO, MnO, NiO, CrO, EuO, FeO, or SmO;

oxides based on the elements Ti, V, Cr, Mn, Fe, Co, Ni, Cu, Zn, Zr, Nb, Mo, Ce, Ta, W, Sm, Eu, Gd, Yb, or La;

carbonates such as MgCO₃xH₂O and La (CO₃)₂xH₂O, oxycarbonates, and proton-conducting oxides having a perovskite structure, e.g. strontium barium cerium oxide, barium calcium niobate, etc. In one embodiment the water-containing nanosize particles comprise bayerite, pseudoboehmite, gibbsite, hydrargillite, diaspor, or boehmite. In another embodiment, the water-containing nanosize particles comprise V₂O₅*xH₂O where x=1-10; VOₓ*yH₂C where y=1-10 and x=1.5-3; _{Wox}*yH₂O where y=1-10 and x=2-3, Al₂O₃*xH₂O where x=1-10; or mixed forms of these oxides.

The surface OH groups may be modified by interaction with organic compounds, for example by exchanging groups thereon.

The invention also includes a process for producing the polymer/ceramic particle composite comprising the steps of providing the polymer and the nanoparticles with a solvent; and evaporating the solvent, thereby forming the composite. In one embodiment, the polymer and the nanoparticles are dispersed in a solvent to form a composition, further comprising the step of extruding the composition. In another embodiment, the polymer and the nanoparticles are dispersed in a solvent to form a composition, further comprising the step of spraying or applying the composition onto a support. The solvent used is beneficially N-methylpyrrolidinone, N,N-dimethylacetamide, N,N-dimethylformamide, dimethylsulfoxide, sulfolane, tetrahydrofuran, glyme, diglyme, triglyme, tetraglyme, dioxane, toluene, xylene, petroleum ether, or any mixture thereof.

The composite of claims 1 sized and shaped into a fuel cell component, (direct methanol, direct ethanol, H₂ or hydrocarbon fuel cells), a battery component, a hot gas methane reforming for the synthesis of methanol or ethanol component, a component of a hot steam to hydrogen converter, or an electrochemical sensor. The composite also has applications in medical technology and applications in electrocatalysis.

### DESCRIPTION OF THE INVENTION

The invention provides composite materials which are suitable for industrial applications, specifically in energy technology and here particularly for fuel cells for intermediate- and high-temperature operation (temperature above 100° C.) and have a satisfactory proton conductivity up to temperatures of 300° C.

According to the invention, this object is achieved by a material which comprises a polymer component and a heat- and corrosion-resistant, water-containing nanosize inorganic (oxidic) component, with the exception of three-dimensional and sheet silicates. In comparison with conventional materials based on polymer electrolytes, the performance of the material (proton transport) is closely linked to the ceramic component, which, in terms of a simple percolation model, requires a proportion by volume greater than the percolation limit (about 30%) of the system or of the ceramic component. In the case of nonideal particles, e.g. nonspherical, elongated particles, this limit is generally shifted to far lower values.

As polymer component, it is possible to use all polymers which have a good heat resistance. Heat-resistant, weakly ion- or proton-conducting polymers such as polybenzimidazole (PBI) are advantageous, but not absolutely necessary. The same applies to weakly electron-conducting polymers (boundary conditions: electronic conductivity at least 1-2 orders of magnitude lower than proton conductivity). All the last-named materials are materials having a wide band gap, typically in the order of Eg>2 eV.

The components which can be used and also their possible combinations are described in more detail below.

Polymers which can be used:

1. All heat-resistant unfunctionalized polymers, in particular:

polymers having aryl main chains (e.g. polyether sulfones, polyether ketones, polyphenylene oxides, polyphenylene sulfides)

polymers having hetaryl main chains (e.g. polybenzimidazoles, polyimidazoles, polypyrazoles, polyoxazoles, . . . )

2. Ionomers containing SO₃H, COOH, PO₃H₂ cation-exchange groups and preferably having an aryl or hetaryl backbone

3. Ionomers containing anion-exchange groups NR₃⁺X⁻ (where R is H, aryl, alkyl, and where X═F, Cl, Br, I)

4. Precursors of the ionomers containing, for example, SO₂C₁, SO₂NR₂, —CONR₂, etc. groups or NR₂ groups (where R is H, aryl, alkyl)

5. Ionomer blends

6. Polymers having acidic and other functional groups on the same polymer main chain

The polymers and polymer blends can additionally be covalently crosslinked.

Ceramic Materials which can be used

The (inorganic)ceramic component of the composite consists to a large extent of a water-containing stoichiometric or nonstoichiometric oxide MₓO_{y}*n H₂O, or a mixture of oxides, where M is one of the elements Al, Ce, Co, Cr, Mn, Nb, Ni, Ta, La, V and W. Ceramic components in which SiO₂ is the predominant constituent are not within the scope of the present patent. All ceramic materials are in the form of nanocrystalline powders (1-100 nm) which have a surface area of >100 m²/g. The preferred particle size is 10-50 nm. Important factors for a high proton mobility are a high water content (greater than 10-50% by weight) and a sufficient acidity or basicity of the surface groups (—OH). The formation of water-containing sheet structures in the volume of some of the abovementioned oxides is advantageous, since a high proton mobility and proton buffer capacity are then also present in the volume. A typical material worthy of mention is proton-exchanged beta-aluminum oxide (and mixtures comprising this material). Apart from the abovementioned materials, it is also possible to use carbonates and hydroxycarbonates or their mixtures with the oxides.

Furthermore, it is possible to use the oxides having a perovskite structure which conduct protons at elevated temperatures (300<T<700° C.) as component for a ternary composite oxide 1/polymer/oxide2, which makes an increase in the use temperature possible. The latter is limited solely by the decomposition temperature of the polymer component used, i.e. in the case of optimized thermoplastics T<700° C. When the element Al is the main constituent of the ceramic component, aluminum oxide compounds which may contain up to 35% by weight of water (the appended table lists typical compositions for the aluminates and also their thermophysical properties) are obtained. In the case of V and W, analogous oxide components or precursors comprising heteropolyacids or gel-like compounds and having the abovementioned necessary structural properties are obtained. Particularly advantageous composite properties are obtained when, preferably, ceramic powder comprising bayerite, pseudoboehmite or proton-exchanged B-aluminate as well as mixed oxides comprising WOₓ(2<x<3.01), V₂C₅ or MnC₂ and containing up to 40% by weight of water are used as further component.

When using these last-named materials, the thermal stability of the composite material rises to at least 300° C. at a relative humidity of 60-70%. Increasing the atmospheric humidity and/or increasing the working pressure increases the use temperature to about 500° C.

Advantages of the composites of the invention include:

H₂O storage capability up to 250-300° C. at atmospheric pressure (up to 500° C. under superatmospheric pressure)

Proton and OH— ion conduction via water- and hydroxyl-containing interface structure up to at least 250° C.

Targeted variation of the local charge carrier binding strength is possible by means of different polar groups on the polymer skeleton or on the ceramic particle surface, for example, to provide a reduction in permeation of methanol

Improved mechanical stability compared to ceramic and sometimes also polymeric proton-conducting materials

Ready shapeability, particularly for producing shaped bodies, e.g. tubes, crucibles, semifinished parts, as are used in SOFCs, batteries and/or electrocatalytic (membrane) reactors

Reduced water management requiring intensive maintenance and subject to substantial regulation in plant operation at T>100° C. Owing to the high H₂O buffer capacity of the composite material (thermodynamic property of the ceramic powder), the high proton concentration necessary for use is established completely spontaneously and can ensure stable operation under reduced pressures. This opens up novel fields of application for such a composite membrane, for instance in low-maintenance gas sensors or maintenance-free hydrogen pumps in plant technology, especially nuclear technology.

Use of polymers which are not proton conductors is possible (limiting case exclusively proton transport via volume/interface of the percolating oxide particles)

Mechanical property profile of a ceramic, e.g. thermomechanical strength, increased impact toughness and hardness, but with the manufacturing methods of polymer materials, e.g., extrusion, tape casting, deep drawing, etc . . .

Low water partial pressure at operating temperatures above 120° C., thus low degradation tendency

All components of the composite are commercially available and inexpensive.

The simple manufacturing process is easily scaled up for mass production.

Processes suitable for producing and processing such a composite material are:

Tape casting (mixing the ceramic powder into a polymer solution, homogenizing, tape casting, evaporating the solvent)

Extrusion of the polymer/solvent/ceramic suspension

Spraying/applying the polymer/solvent/ceramic suspension onto a support

Spin coating

The polymer/ceramic particle composites of the invention are not polymer ceramics in the sense of the precursor-based pyrolysis ceramics which lead to SiC, SiCN, SIBCN, Si₃N₄ mixed ceramics for high-temperature applications above 1300° C. The term “polymer ceramic” is used for structural ceramics (see above) which are produced from organometallic compounds by pyrolysis. See: polysilazanes, polysilanes, polycarbosilanes, SiBCN ceramic, etc.

What is claimed is:

1. A proton-conducting polymer/ceramic particle composite or polymer/ceramic particle composite membrane, characterized in that it comprises a heat-resistant polymer and nanosize oxide containing intercalated water and at the same time having a high concentration of acidic/basic surface OH, wherein the nanosize particles have surface areas of >>20 m²/g, and a mean diameter of <<100 nm.

2. The proton conductor of claim 1, characterized in that it has a ratio of polymer:oxide of from 99:1 to 70:30 in % by volume.

3. A proton conductor of claim 1, characterized in that it has a percolating ceramic particle network such that in terms of a simple percolation model has a mixing ratio of polymer:oxide of >30% by volume.

4. The proton conductor of claim 3 wherein proton conduction is exclusively via the percolating ceramic particles and their boundary layer to the polymer.

5. The proton conductor of claim 4, characterized in that it comprises one or more thermally stable polymer components.

6. The proton conductor of claim 1, characterized in that the proton conductor has a proton conductivity of >>10⁻⁵ S/cm at T>100° C. and an electrical conductivity of comparable magnitude or less.

7. The proton conductor of claim 6, characterized in that the proton conductor has an electrical conductivity of at least an order of magnitude lower than the proton conductivity.

8. The proton conductor of claim 1 shaped in the form of a flat article, a film, a membrane, or an (electro)catalytic electrode.

9. The proton conductor of claim 1 shaped in the form of tubes or crucibles by an extrusion or pressing process.

10. The proton conductor of claim 1, characterized in that the proton conductor is stable at 250° C.

11. The proton conductor of claim 10, characterized in that the polymer has an aryl or hetaryl main chain.

12. The proton conductor of claim 1, characterized in that the main chain polymer comprises at least one of the following building blocks:

| R_{aromatic:} | R_{bridge:} |
|---|---|
| 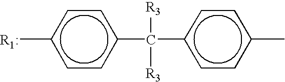 | 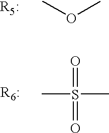 |
| 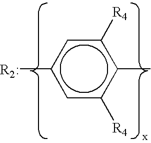 | 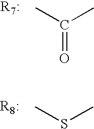 |

13. The proton conductor of claim 12, characterized in that the main chain polymer is selected from the group consisting of Poly(ether ether ketone) of formula [R₅—R₂—R₅—R₂—R₇]ₙ, where n is an integer, x=1, and R₄=H; Poly(ether sulfone) of formula [R₁—R₅—R₂—R₆—R₂—R₅]ₙ, R₂, where n is an integer, x=1, and R═H; Poly(ether sulfone) of formula [R₂—R₆—R₂—R₅]ₙ, R₂, where n is an integer, x=1, and R₄=H; Poly(phenyl sulfone) of formula [(R₂)₂—R₅—R₂—R₆—R₂]ₙ, R₂, where n is an integer, x=2, R₄═H; Polyether ether sulfone of formula ([R₅—R₂—R₅—R₂—R₆]ₙ—[R₅R₂—R₆—R₂]ₘ, [R₅—R₂—R₆—R₂]ₘ, R₂, where x=1, R₄═H, n and m are integers such that n/m=0.18; Poly(phenylene sulfide) of formula [R₂—R₈]ₙ, R₂, where n is an integer, x=1, R₄═H; or Poly(phenylene oxide) of formula ([R₂—R₅]ₙ, where n is an integer, R₄═CH₃.

14. The proton conductor of claim 1, characterized in that the hetaryl main chain polymer comprises at least one of the following building blocks:

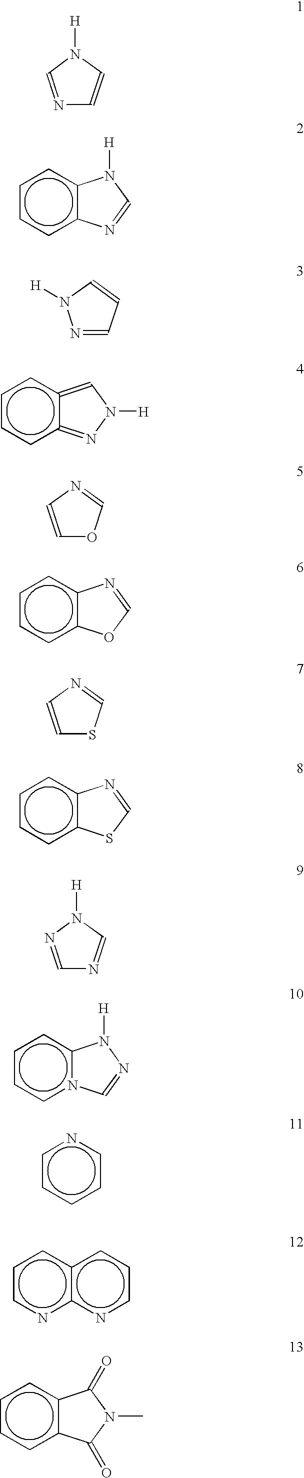

15. The proton conductor of claim 14 wherein the hetaryl polymers comprise polyimidazoles, polybenzimidazoles, polypyrazoles, polybenzopyrazoles, polyoxazoles, or polybenzoxazoles.

16. The proton conductor of claim 1, characterized in that the polymer comprises cation-exchange groups —SO₃M, —PO₃M₂, —COOM, or —B(OM)₂, where M is H, a monovalent metal cation, ammonium, or NR₄ where R is independently H, alkyl, or aryl; or
precursors: SO₂X, COX, or PO₃X₂ where X═F, Cl, Br, I, or OR, where R is an alkyl or aryl.

16. The proton conductor of claim 1, characterized in that the polymer comprises at least one of the anion-exchange groups NR₄, where R is independently H, alkyl, aryl, pyridinium, imidazolium, pyrazolium, or sulfonium.

17. The proton conductor of claim 1, characterized in that the ceramic component is selected from among:
water-containing and nanosize particles which have OH groups on their surface;
protonated, ion-exchanged mixed oxides which in their original parent compositions form the B-aluminate structure selected from the group consisting of

| | | |
|---|---|---|
| zMe₂O-xMgO-yAl₂O₃ | zMe₂O-xZnO-yAl₂O₃ | zMe₂O-xCoO-yAl₂O₃ |
| zMe₂O-xMnO--yAl₂O₃ | zMe₂O-xNiO-yAl₂O₃ | zMe₂O-xCrO-yAl₂O₃ |
| zMe₂O-xEuO-yAl₂O₃ | zMe₂O-xFeO-yAl₂O₃ | zMe₂O-xSmO-yAl₂O₃ |

or mixed forms of these oxides, where the empirical formulae describe the ranges in which the parent compounds, Me is Na or K, and where the compounds containing alkali metals have been subjected, before they can be used for the membrane, to an ion-exchange process in which the alkali metal ion is removed and the protonated form of the B-aluminate compound is produced, wherein, z=0.7-1.2, x=0.1-10, y=0.1-10, and wherein the proton conductor stable to about 300° C.;
compositions comprising the components MgO, ZnO, CoO, MnO, NiO, CrO, EuO, FeO, or SmO;
oxides based on the elements Ti, V, Cr, Mn, Fe, Co, Ni, Cu, Zn, Zr, Nb, Mo, Ce, Ta, W, Sm, Eu, Gd, Yb, or La;
carbonates, oxycarbonates, or proton-conducting oxides having a perovskite structure.

18. The proton conductor of claim 17, wherein the water-containing nanosize particles comprise bayerite, pseudoboehmite, gibbsite, hydrargillite, diaspor, or boehmite.

19. The proton conductor of claim 17, wherein the water-containing nanosize particles comprise V₂O₅*xH₂O where x=1-10; VOₓ*yH₂C where y=1-10 and x=1.5-3; Woₓ*yH₂O where y=1-10 and x=2-3, Al₂O₃*xH₂O where x=1-10; or mixed forms of these oxides.

20. The proton conductor of claim 17, characterized in that the surface OH groups are modified by interaction with organic compounds.

21. A process for producing a polymer/ceramic particle composite of claim 1 comprising the steps of
providing the polymer and the nanoparticles with a solvent; and
evaporating the solvent, thereby forming the composite.

22. The process of claim 21, wherein the polymer and the nanoparticles are dispersed in a solvent to form a composition, further comprising the step of extruding the composition.

23. The process of claim 21, wherein the polymer and the nanoparticles are dispersed in a solvent to form a composition, further comprising the step of spraying or applying the composition onto a support.

24. The process of claim 21, characterized in that the solvent used is N-methylpyrrolidinone, N,N-dimethylacetamide, N,N-dimethylformamide, dimethylsulfoxide, sulfolane, tetrahydrofuran, glyme, diglyme, triglyme, tetraglyme, dioxane, toluene, xylene, petroleum ether, or any mixture thereof.

25. The composite of claims 1 sized and shaped into a fuel cell component, a battery
component, a hot gas methane reforming unit component for the synthesis of methanol or ethanol, a component of a hot steam to hydrogen converter, or an electrochemical sensor.
